(19) United States
(12) Patent Application Publication
(10) Pub. No.: US 2026/0070705 A1
(43) Pub. Date: Mar. 12, 2026

(54) Resealable Bag Topper

(71) Applicant: Sarah Creates LLC, Aspen, CO (US)

(72) Inventor: Sarah Pierce, Aspen, CO (US)

(21) Appl. No.: 19/324,610

(22) Filed: Sep. 10, 2025

Related U.S. Application Data
(60) Provisional application No. 63/693,453, filed on Sep. 11, 2024.

(51) Int. Cl. B65D 33/16; B32B 7/12; B32B 25/20; B32B 27/32; B65D 33/25; B65D 33/28

(52) U.S. Cl. CPC B65D 33/1691; B32B 7/12; B32B 25/20; B32B 27/32; B65D 33/2508; B65D 33/28; B32B 2250/02; B32B 2250/242; B32B 2439/06; B65D 2313/02; B65D 2313/04

(57) ABSTRACT

A resealable bag topper for application to a non-resealable packaging bag is disclosed. An example device includes a flexible topper body defining an access channel, a resealable mechanism such as a zipper or slider closure to open and close the channel, and an adhesive portion for affixing the body to the bag. To enable multiple uses of the device, the adhesive portion is specially configured. In one example, the adhesive portion includes a repositionable adhesive or a multi-layer assembly of stacked adhesive layers that enables the entire device to be removed from a first bag and reapplied to a subsequent bag. In another example, the adhesive portion is made integral with the topper body.

### PRIORITY CLAIM

This application claims the priority filing benefit of U.S. Provisional Patent Application No. 63/693,453 filed Sep. 11, 2024 for “Resealable Bag Topper” of Sarah Pierce, hereby incorporated by reference in its entirety as though fully set forth herein.

### BACKGROUND

Bags are a common packaging format for a wide range of food and snack items, such as chips, cereal, and vegetables. However, a significant drawback is the inability to reseal the package after it has been opened.

The inability to reseal these bags poses a substantial problem, primarily leading to the rapid degradation of food products due to exposure to air and moisture. Staleness is often caused by the oxidation of fats and oils within the food, resulting in an unpleasant taste and a decrease in nutritional value. Stale food not only results in a loss of taste and texture but can also lead to food waste. Moisture from humidity in the air can cause food to lose its crispy texture.

Existing solutions for resealing food packaging include the common “chip clip”. But this falls short, providing only a limited ability to remove air entirely from the bag and prevent the ingress of air and moisture. It still contributes to food spoilage and waste.

Another alternative is the “bag vacuum sealer.” This provides two modes of operation. The first mode requires the user to transfer the contents of the bag into a vacuum sealable bag, where the vacuum function evacuates air to extend the shelf life of the contents. However, this method may not be suitable for items like chips or bread as the vacuum may inadvertently crush the contents. The second mode of operation for the vacuum sealer is a “reseal” option, allowing the user to create an airtight seal along the bag's opening. However, in order to access the contents again, the user is required to cut the bag open, rendering it inconvenient for repeated use and contributing to single-use packaging waste.

### BRIEF DESCRIPTION OF THE DRAWINGS

FIG. 1 shows an example resealable bag topper device.

FIG. 2 shows the example resealable bag topper device of FIG. 1 as it may be attached to an open snack bag (such as a potato chip bag) by an adhesive and sealed on top.

FIG. 3 shows the example resealable bag topper device of FIG. 1 as it may be opened on top by the user to access content (e.g., the potato chips or other snack) in the bag.

FIG. 4 shows another example resealable bag topper device.

FIG. 5 shows the example resealable bag topper device of FIG. 4 as it may be attached to an open snack bag (such as a potato chip bag) by an adhesive and sealed on top.

### DETAILED DESCRIPTION

Conventional methods for resealing bags are often ineffective, leading to food spoilage and waste. Consumers may resort to purchasing single-serve packaging to preserve freshness, which increases packaging waste and consumer cost. Therefore, a need exists to improve the resealability of standard bags, thereby reducing food waste and the reliance on single-use packaging.

This disclosure describes a resealable bag topper device for application to standard packaging bags, such as snack bags, cereal bags, and other common food storage bags. The resealable bag topper device provides the functionality of a zipper storage bag closure for a conventional, non-resealable bag. This enables a user to convert the conventional, non-resealable bag into a resealable bag or container.

An example of the device includes a topper body, an adhesive portion, and a resealable mechanism. The topper body includes a durable and flexible material configured to be substantially airtight. The resealable mechanism is disposed at or near a top edge of the topper body. In some configurations, the resealable mechanism is a zipper seal that provides an airtight closure. The adhesive portion may be a peel-and-stick configuration. This peel-and-stick configuration enables the topper body to be stored until ready for use, and then to be adhered securely to the surface of a snack bag, below the snack bag opening. The adhesive portion can also function to close or repair tears that may form in the bag material during initial opening, for example by positioning the adhesive portion on top of or below a tear in the snack bag so that the opening from the tear is within the sealed portion of the topper body.

When the device is secured to a snack bag, the resealable mechanism creates a substantially airtight seal to preserve the freshness of the contents in the bag. The application of the device does not require cutting the bag or utilizing complex sealing equipment. A user can reseal the snack bag by engaging the resealable mechanism.

The described resealable bag topper device provides a technical solution for resealing standard packaging and snack bags. Use of the device can reduce the need for supplemental single-serve packaging, which consequently mitigates food waste and associated consumer expenditures. The device thus provides a method for maintaining the freshness of a wide range of food and snack items provided for consumers in conventional packaging bags. The resealable bag topper device is a breakthrough solution for resealing standard bags with simplicity and efficiency.

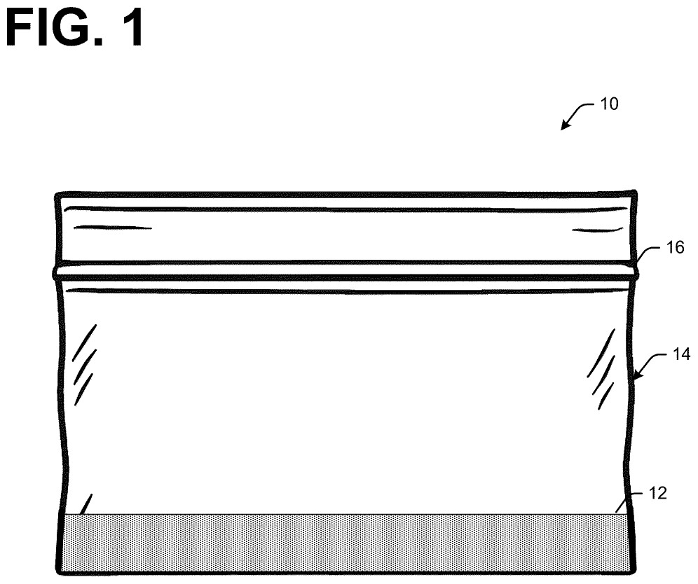

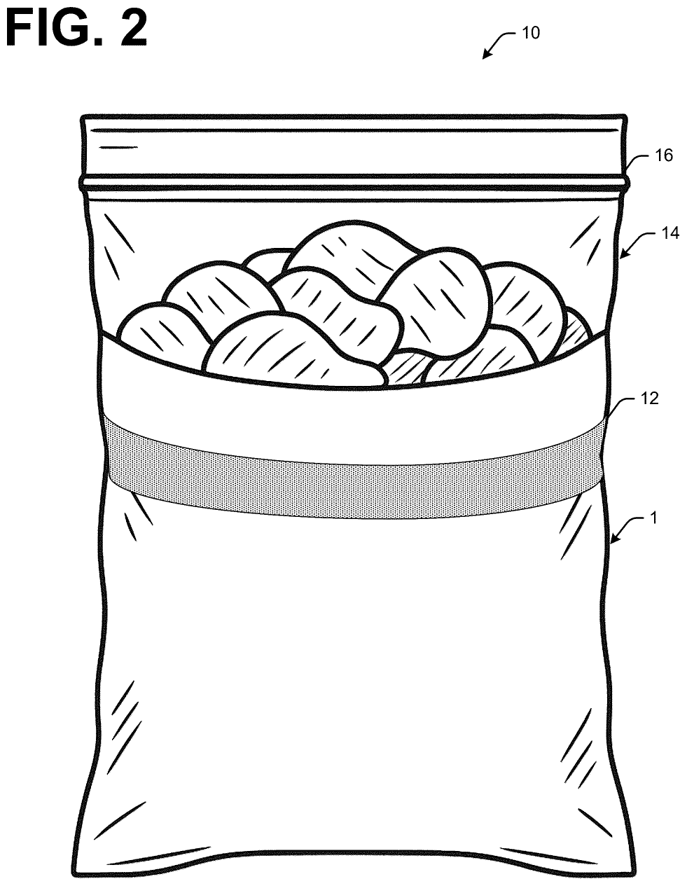

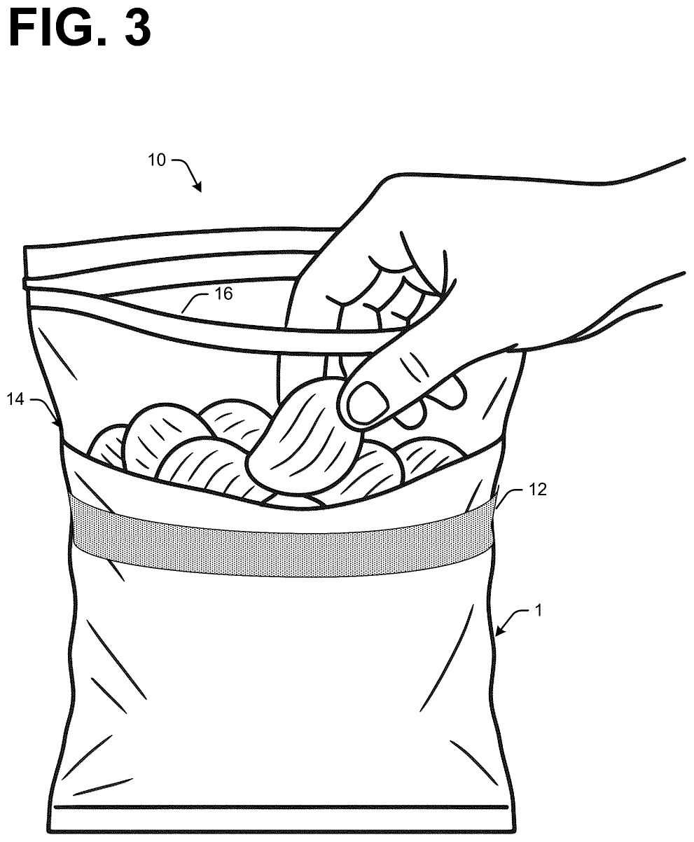

Before continuing, it is noted that as used herein, the terms “includes” and “including” mean, but is not limited to, “includes” or “including” and “includes at least” or “including at least.” The term “based on” means “based on” and “based at least in part on.” FIG. 1 shows an example resealable bag topper device 10. FIG. 2 shows the example resealable bag topper device 10 of FIG. 1 as it may be attached to an open snack bag 1 (such as a potato chip bag) by an adhesive portion 12 and a topper body 14 that can be sealed by a resealable mechanism 16 on top. FIG. 3 shows the example resealable bag topper device 10 of FIG. 1, as it may be opened on top by the user to access its contents (e.g., the potato chips or other snack).

An example resealable bag topper device 10 includes a topper body 14, an adhesive portion 12 disposed on the topper body 14, and a resealable mechanism 16 integrated with the topper body 14. The topper body 14 is a structural component configured to be placed over an opening of a packaging bag 1. The adhesive portion 12 is configured to affix the topper body 14 to the packaging bag material surrounding the opening. The resealable mechanism 16 is located on the topper body 14 and provides a means for repeated sealing and unsealing of an access channel through the topper body 14.

In an example, the resealable mechanism 16 operates between an open configuration and a closed configuration. In the open configuration, the resealable mechanism 16 defines an unobstructed pathway through the topper body 14 that aligns with the opening of the packaging bag 1, which enables a user to dispense contents from the bag 1. In the closed configuration, the resealable mechanism 16 obstructs the pathway to seal the topper body 14, which consequently seals the opening of the packaging bag 1 from the ambient environment.

In an example, the adhesive portion 12 is configured to form a first seal between the topper body 14 and the packaging bag 1 that is substantially airtight and moisture-resistant. The resealable mechanism 16, when in the closed configuration, is configured to form a second, repeatable seal that is also substantially airtight and moisture-resistant. In an example, the resealable mechanism 16 includes a zipper seal, such as a pair of interlocking male and female profiles that a user can press together to close and pull apart to open. Other example resealable mechanisms can include slide-seal closures.

In an example, the topper body 14 is fabricated from a durable and flexible material. Suitable materials include, but are not limited to, various polymers, such as low-density polyethylene (LDPE), polypropylene, or other thermoplastic elastomers. The durability of the material enables the resealable mechanism 16 to withstand numerous opening and closing cycles without degradation. The flexibility of the material enables the topper body 14 to conform to the contours of the packaging bag 1, which facilitates the formation of a continuous and secure seal by the adhesive portion 12.

The specific material selection may be based at least in part on design considerations, such as the intended use case and desired product life of the device 10. For example, when the device 10 is configured for single or limited use, the topper body 14 can be manufactured of a thin, flexible polymer such as low-density polyethylene (LDPE) or polypropylene, as described above. These materials provide sufficient durability to withstand numerous opening and closing cycles for the typical lifespan of the packaged contents. But in other examples configured for extended durability and a longer product life, the topper body 14 can be fabricated from a thicker gauge of polymer or from more resilient materials, such as silicone or thermoplastic elastomers (TPE). Materials such as silicone offer enhanced flexibility and a higher resistance to material fatigue, which enables the device 10 to maintain its structural integrity and sealing capability over a significantly greater number of cycles.

Regardless of the specific material composition, the flexibility of the topper body 14 enables it to conform to the contours of the packaging bag 1, which facilitates the formation of a continuous and secure seal by the adhesive portion 12.

The adhesive portion 12 can be provided on the topper body 14 as a layer of pressure-sensitive adhesive applied to a surface of the body. In an example, the adhesive portion 12 is covered by a removable release liner. To apply the device 10, a user removes the release liner to expose the adhesive portion 12 and presses the topper body 14 onto the packaging bag 1. The adhesive portion 12 is configured to bond to the surfaces of the bag 1 adjacent to the opening, thereby securing the topper body 14 in place. Furthermore, the adhesive portion 12 can span across and seal minor tears or perforations in the packaging bag material that may occur during initial opening.

In an example, the adhesive portion 12 can be made integral with the topper body 14 by incorporating it directly into the material during the manufacturing process, rather than applying it as a separate component afterward. This ensures that the adhesive is a permanent and inseparable part of the device 10. This may be accomplished in a variety of ways.

By way of illustration, the adhesive portion 12 is made integral with the topper device 14 during manufacture by co-extrusion. In this example, the main polymer (e.g., polyethylene or polypropylene) that forms the topper body 14 is extruded simultaneously with one or more layers of a different polymer that has inherent adhesive properties and thereby forms the adhesive portion 12. Co-extrusion processes implement multiple extruders that feed different molten polymers into a single die. The die combines these molten streams into a single, multi-layered film. The outermost or innermost layer of the film that will form the bottom opening of the bag is made from a tackifier resin or a polymer that acts as a permanent pressure-sensitive adhesive. As such, the layers are fused together at the molecular level as they cool, creating a single, unified sheet of material. As such, the adhesive portion 12 is not just on the topper body 14, it is a layer of (i.e., integral with) the topper body 14 itself. This bond is permanent and seamless.

By way of further illustration, the adhesive portion 12 can be integrated with the topper body 14 by applying the adhesive material as a liquid resin that chemically bonds to the material of the topper body 14 as it cures. For example, a liquid adhesive, such as a UV-curable acrylate or silicone can be precisely applied to the device material and then exposed to ultraviolet (UV) light or other activator to initiate a chemical reaction (e.g., polymerization) that cures the liquid into a solid, permanent, and tacky adhesive portion integral with the topper body 14 itself. The curing process forms strong covalent bonds between the adhesive polymer and the polymer substrate of the topper body 14. This bond ensures that the adhesive portion 12 cannot be delaminated or separated without destroying the material of the topper body 14 itself.

Still other processes may be implemented, such as but not limited to, static cling film integration wherein a band of static cling vinyl or a similar polymer can be integrated into the topper body 14 of the device 10. Although still referred to herein as an “adhesive portion,” this technique works by the static cling material naturally adhering to the smooth surface of the snack bag 1 through electrostatic forces, creating a light but effective seal sufficient to maintain freshness of the contents of the snack bag 1.

In yet another example, the lower portion of the topper body 14 of device 10 can be attached to the snack bag 1 through mechanical and/or physical techniques, such as but not limited to, mechanical fastening mechanisms (e.g., clamp or clips) Hook and Loop Fasteners (e.g., VELCRO®), high-friction or “tacky” elastomer seal (e.g., a non-adhesive, high-coefficient-of-friction material, such as a soft silicone or thermoplastic elastomer (TPE), shape-based and interlocking designs (e.g., dual-ring snap-fit mechanisms). These and other techniques are well understood and can be readily implemented for the device 10 disclosed herein by those having ordinary skill in the art after becoming familiar with the teachings herein.

A primary challenge with affixing a reusable device, such as the resealable bag topper device 10, to a disposable package (e.g., the snack bag 1) is the nature of the adhesive bond. A standard permanent adhesive creates a strong, reliable seal, but in doing so, it permanently joins the topper body 14 to a single packaging bag 1. This configuration renders the entire device 10 a single-use item that must be discarded along with the empty snack bag 1. Such a result is inefficient and can add cost to the snack in the snack bag 1, as the durable, functional components of the topper body 14 and its resealable mechanism 16 are disposed of prematurely after only a single use.

To counteract this, the resealable bag topper device 10 may include an adhesive system that enables the topper body 14 and resealable mechanism 16 to be utilized multiple times. The following examples describe adhesive configurations that extend the product's life, thereby enhancing its sustainability and value to the consumer.

To enable true reusability where the resealable bag topper device 10 is transferred between packages, one example adhesive system includes an adhesive portion 12 including a repositionable adhesive. This class of pressure-sensitive adhesive is specifically formulated to have a lower peel adhesion and a higher cohesive strength relative to permanent adhesives. The high cohesive strength ensures the adhesive does not split or tear apart during removal, while the lower peel adhesion enables it to be separated from a surface with minimal force. This formulation is configured to release cleanly from low surface energy substrates, such as the polymer films common in snack packaging, without leaving adhesive residue. This repositionable adhesive is applied, as the adhesive portion 12, as a continuous or patterned layer to the bonding surfaces of the topper body 14.

The functional application of the repositionable adhesive enables reuse of the resealable bag topper device 10. In an example, the user first applies the resealable bag topper device 10 to a packaging bag 1 with firm pressure to initiate the temporary bond. Once the contents of the bag are consumed, the user can grip the topper body 14 and peel it away from the surface of the snack bag 1, typically using a steady, low-angle force. The adhesive releases its bond, leaving the snack bag 1 substantially intact and the adhesive layer ready for its next application. Because the adhesive is configured to retain its tackiness, the user can then align and press the same resealable bag topper device 10 onto a new packaging bag, forming another secure, reliable seal. This process transforms the resealable bag topper device 10 from a disposable item into a durable tool that can service multiple packages sequentially, significantly reducing waste.

Another example for a reusable resealable bag topper device 10 includes a multi-layer adhesive assembly as the adhesive portion 12. This assembly, or laminate stack, is permanently affixed to the topper body and includes a plurality of stacked, repeating units. Each unit consists of a thin-film layer of permanent, high-tack adhesive and an overlying release liner, such as a siliconized film. The stack can be configured with any number of units, for example from two to ten or more, to provide a corresponding number of reuse applications for the resealable bag topper device 10. The release liner for each layer may include a small, non-adhesive tab or “dry edge” to provide a user with a graspable area to facilitate removal.

The mechanism of this multi-layer system relies on a differential of bond strengths. The bond strength between any given adhesive layer and a target packaging bag 1 is configured to be significantly greater than the bond strength between that same adhesive layer and the surface of the subsequent, underlying release liner in the laminate stack. When a user is finished with a bag and pulls the topper body 14 away from the snack bag 1, the force applied causes the laminate to delaminate at its weakest point. Because the adhesive-to-bag bond is strongest, the used adhesive layer separates from the underlying release liner and remains permanently affixed to the disposable bag. The resealable bag topper device 10, now removed, presents a clean, fresh release liner as its exposed surface. The user can then peel this liner away to reveal the next unused adhesive layer, rendering the device ready for immediate application to a new snack bag 1.

It is noted that the examples described herein are provided for purposes of illustration, and are not intended to be limiting. Other devices and/or device configurations may be utilized to carry out the operations described herein.

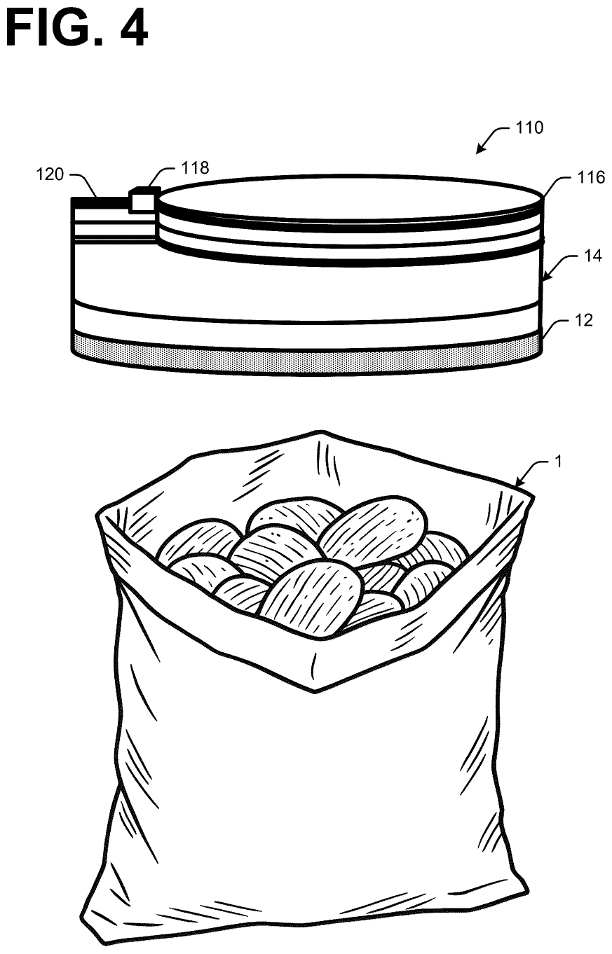

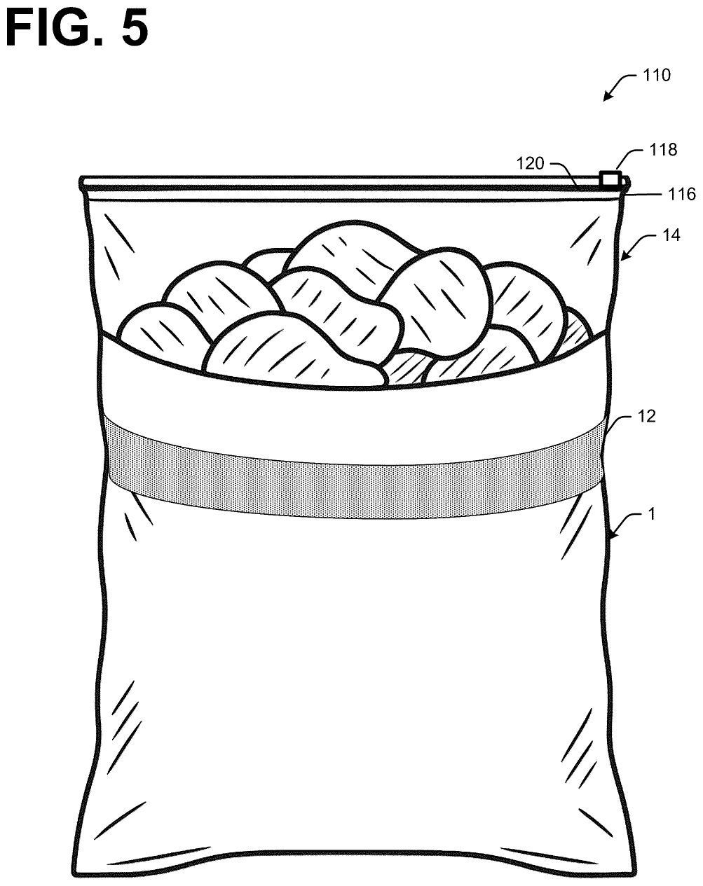

FIG. 4 shows another example resealable bag topper device 100. FIG. 5 shows the example resealable bag topper device 100 of FIG. 4 as a topper body 14 may be attached to an open snack bag 1 (such as a potato chip bag) by an adhesive portion 112 and sealed on top by the resealable mechanism 116. It is noted that examples described above for the adhesive portion 12 and topper body 14 of the resealable bag topper device 10 may also be implemented for the adhesive portion 112 and topper body 114 of the resealable bag topper device 100.

In the example resealable bag topper device 100 shown in FIGS. 4 and 5, the resealable mechanism 116 includes a slider closure 118. This configuration includes a pair of parallel, interlocking tracks 120 integrated into the topper body 114 and a slider element 118 that movably engages with the tracks 120. The slider element 118 (e.g., configured as a rigid plastic clip) straddles both tracks 120. When a user moves the slider element 118 in a first direction, an internal geometry within the slider element 118 forces the interlocking profiles of the tracks 120 to engage and form a continuous seal. Moving the slider element 118 in a second, opposite direction causes a separating member (not shown) on the slider element 118 to disengage the tracks 120, thereby opening the seal. This slider-based mechanism provides a distinct tactile and visual confirmation of the seal status.

Still other examples of closure mechanisms are contemplated. For example, the resealable bag topper device may include a fold-over closure mechanism to seal the topper body. This configuration includes an extended flap that is integral with or attached to one side of the topper body. The inner surface of this flap includes a strip of resealable, pressure-sensitive adhesive. To seal the device, a user folds the flap over the access opening and presses the adhesive strip firmly against a corresponding surface on the topper body. This action creates a substantially airtight seal, and the properties of the resealable adhesive enable a user to peel open and re-secure the flap multiple times.

Another example device can include a drawstring closure. In this configuration, the upper portion of the topper body includes a continuous channel or hem through which a flexible drawstring is threaded. A user seals the device by pulling the ends of the drawstring, which constricts the channel and cinches the flexible material of the topper body together, thereby closing the access opening. To maintain the closure, the device can include a locking element, such as a cord clamp or a spring-loaded toggle, configured to hold the drawstring under tension. Releasing the locking element and relaxing the tension on the drawstring enables the opening to be expanded.

In another example, the closure mechanism may be a magnetic closure. In this configuration, the opposing edges of the topper body that define the access opening each include an embedded or affixed flexible magnetic strip. When a user brings these edges into proximity, the magnetic attraction pulls them together, creating a continuous seal along their length. This provides a self-aligning and self-closing mechanism that a user can easily operate. The flexibility of the magnetic strips enables them to conform to each other, maintaining a consistent seal.

In another example, the closure mechanism may include a series of discrete mechanical snaps or clasps. In this system, one edge of the access opening is populated with a plurality of male snap components, and the opposing edge includes a corresponding plurality of female snap components. A user secures the closure by aligning and pressing each male-female pair together until they engage, which is often confirmed by a tactile or audible click. The seal is formed by the material compression between each engaged snap point, and placing the snaps in close proximity creates a substantially continuous closure.

A method of operating the resealable bag topper device is also contemplated. In an example, the method includes the operation of peeling off a protective cover from the adhesive backing of the topper. The method also includes the operation of aligning the topper with the opening of the packaging bag. This can help ensure that the peel-and-stick technology on each side of the packaging bag adheres securely just under the opening. The method includes the operation of pressing the topper onto the packaging bag to form an airtight seal, effectively resealing the bag.

In an example, opening the zipper seal at the top of the topper forms a new opening to access contents of the packaging bag. Pressing the zipper seal reseals the bag.

The operations described herein are provided to illustrate example implementations. It is noted that the operations are not limited to the ordering shown. Still other operations may also be implemented.

The combination of the topper, adhesive portion, and resealable mechanism creates an innovative and user-friendly solution for preserving the freshness of a wide range of food and household items. Effectively, once the topper is applied to an already opening packaging bag, the top of the packaging bag resembles the closure of a zipper bag. The resealable bag topper device allows users to easily open and close the packaging bag repeatedly without compromising the seal's integrity. It ensures that the contents remain fresh and protected from environmental factors such as air and moisture.

It is noted that the examples shown and described are provided for purposes of illustration and are not intended to be limiting. Still other examples are also contemplated.

1. A resealable bag topper device, comprising:
a topper body configured to be placed over an opening of a packaging bag, the topper body defining an access channel therethrough;
a resealable mechanism disposed on the topper body and configured to selectively open and close the access channel; and
an adhesive portion being integral with the topper body and configured to affix the topper body to the packaging bag, wherein the adhesive portion is configured to enable multiple uses of the device.

2. The device of claim 1, wherein the adhesive portion comprises a repositionable adhesive configured to form a temporary bond with the packaging bag.

3. The device of claim 2, wherein the repositionable adhesive is further configured to be removed from the packaging bag without leaving substantial residue and to retain sufficient tackiness for reapplication to a subsequent packaging bag.

4. The device of claim 1, wherein the adhesive portion comprises a multi-layer assembly including a plurality of stacked adhesive layers, wherein each adhesive layer is separated by a release liner.

5. The device of claim 4, wherein each of the plurality of adhesive layers is configured such that its bond strength to the packaging bag is greater than its bond strength to an underlying release liner in the multi-layer assembly, thereby enabling a used adhesive layer to remain on the packaging bag upon removal of the device.

6. The device of claim 1, wherein the resealable mechanism is configured to form a substantially airtight seal when closing the access channel.

7. The device of claim 1, wherein the resealable mechanism comprises a pair of interlocking profiles configured to be pressed together to close the access channel.

8. The device of claim 1, wherein the resealable mechanism comprises a pair of interlocking tracks and a slider movably engaged with the tracks, wherein movement of the slider along the tracks selectively engages or disengages the tracks.

9. The device of claim 1, wherein the resealable mechanism comprises a flap integral with the topper body and a resealable adhesive strip disposed on the flap.

10. The device of claim 1, wherein the resealable mechanism comprises a channel disposed on the topper body and a drawstring threaded through the channel, wherein pulling the drawstring cinches the access channel closed.

11. The device of claim 1, wherein the resealable mechanism comprises a pair of opposing magnetic strips configured to attract one another to close the access channel.

12. The device of claim 1, wherein the resealable mechanism comprises a first strip of hook material and a corresponding second strip of loop material.

13. The device of claim 1, wherein the resealable mechanism comprises a plurality of corresponding male and female snap components.

14. The device of claim 1, wherein the topper body comprises a flexible polymer selected from the group consisting of low-density polyethylene and polypropylene.

15. The device of claim 1, wherein the topper body comprises a resilient material selected from the group consisting of silicone and a thermoplastic elastomer.

16. The device of claim 1, wherein the adhesive portion is integral with the topper body as a layer of adhesive coated directly onto a surface of the topper body.

17. The device of claim 1, wherein the topper body and the adhesive portion are made integral by co-extruding the topper body with a thermoplastic adhesive.

18. The device of claim 1, wherein the adhesive portion is integral with the topper body as a layer that is thermally or chemically bonded to the topper body to form an inseparable laminate structure.

19. A resealable bag topper device, comprising:
a flexible topper body defining an access channel therethrough, the topper body configured to be placed over an opening of a first packaging bag;
a resealable mechanism disposed on the topper body and configured to selectively open and close the access channel; and
a repositionable, pressure-sensitive adhesive disposed on the topper body;
wherein the adhesive is configured to form a temporary bond to affix the topper body to the first packaging bag;
wherein the adhesive is configured to be manually peeled from the first packaging bag without leaving substantial residue thereon; and
wherein the adhesive is configured to retain sufficient tackiness after being peeled from the first packaging bag to affix the topper body to a subsequent packaging bag.

20. A resealable bag topper device, comprising:
a topper body defining an access channel therethrough;
a resealable mechanism disposed on the topper body and configured to selectively open and close the access channel; and
a laminate stack adhesive assembly affixed to the topper body, the laminate stack adhesive assembly comprising a plurality of stacked adhesive layers;
wherein each adhesive layer is separated from an adjacent underlying adhesive layer by an interposed release liner;
wherein an exposed one of the plurality of adhesive layers is configured to form a bond with a packaging bag that is stronger than a bond between the exposed adhesive layer and an underlying one of the release liners, such that upon removal of the topper body from the packaging bag, the exposed adhesive layer delaminates from the laminate stack adhesive assembly and remains on the packaging bag.
